(19) United States
(12) Patent Application Publication
(10) Pub. No.: US 2006/0107697 A1
(43) Pub. Date: May 25, 2006

(54) Method and device for producing precision lenses

(76) Inventors: Peter Muehle, Jena (DE); Kati Proksch, Jena (DE); Bernd Mueller, Schleiz (DE)

Correspondence Address: KENYON & KENYON LLP, ONE BROADWAY, NEW YORK, NY, 10004, US

(21) Appl. No.: 11/198,777

(22) Filed: Aug. 5, 2005

(30) Foreign Application Priority Data
Aug. 9, 2004 (DE) 10 2004 038 793

(51) Int. Cl. C03B 23/00

(52) U.S. Cl. 65/61; 65/105; 65/106

(57) ABSTRACT

The present invention relates to a device and a method for producing an optical lens, especially a precision lens, using a first mold, a convexity being pressed into an essentially plane surface of a glass blank, especially of a glass ingot, without the first mold touching the surface of the convexity or a substantial part of the convexity, and the convexity being pressed into a second mold, the second mold touching a substantial part of the convexity.

### BACKGROUND INFORMATION

The present invention relates to a device and a method for producing a precision lens.

A device and a method for producing an optical lens are described, for example, in U.S. Pat. No. 5,378,255, U.S. Pat. No. 5,160,362, DE 101 49 400 B4, DE 196 33 164 A1, DE 103 48 947 A1, DE 102 34 234 A1 and JP 59195541 A.

DE 196 02 736 A1 describes a device for producing lenses using a matrix which has one or more openings or recesses for the lens to be formed, the relative position of the openings or recesses corresponding to the lenses to be formed, and having a pressure mechanism with the aid of which a molded material is able to be pressed into the openings or recesses in the matrix in a pressure direction, the matrix touching the microlens to be formed only in an edge region that is essentially outside the optical surface.

DE 102 59 890 A1 describes a method for the aftertreatment of the surface contour of at least one optical lens, especially a microlens, made of glass or a glass-like material, having a convexly developed lens surface that is bounded by a circumferential line which is adjacent to a planar section of an area that surrounds the circumferential line, along the circumferential line of the optical lens, on the surface section, a means being applied that is adapted to hug the circumferential line, and borders on the convexly developed lens surface at least laterally, the optical lens being heated to the temperature of at least the transformation temperature of the glass or the glass-like material, and after a certain period, during which the optical lens is exposed to the heat treatment, and subsequent cooling below the transformation temperature, the means being removed from the optical lens.

EP 0 011 331 B1 describes a method for producing a matrix tool.

U.S. Pat. No. 5,160,362, named at the outset, describes a method that is suitable for pressing precision lenses.

The object of the present invention is to improve the production of precision lenses. In this context, it is particularly desirable to produce precision lenses more cost-effectively.

### SUMMARY OF THE INVENTION

The object named above is attained by a method for producing an optical lens, especially a precision lens, using a first mold, (in a first pressing method step), a convexity being pressed into an essentially plane surface of a glass blank or a glass ingot, without the first mold touching the surface of the convexity or a substantial part of the convexity, and the convexity (in a second pressing method step) being pressed into a second mold (in particular, to form a precision lens or rather a precision lens blank, the second mold touching a considerable part of the convexity.

A precision lens, within the meaning of the present invention, is particularly a lens whose contour does not deviate from a desired setpoint contour by more than 1 μm, and/or whose surface roughness amounts to no more than 5 nm. Surface roughness in the sense of the present invention is to be defined in particular as Ra, especially in accordance with ISO 4287.

A considerable part of the convexity within the meaning of the present invention is especially that part of the convexity which, or rather, whose surface influences the optical properties of a precision lens pressed from the convexity.

In one embodiment of the present invention, the blank or the glass ingot is heated to a certain temperature before the pressing of the convexity, using the first mold.

In one embodiment of the present invention, the temperature is selected as a function of a desired geometrical shape of the convexity or, at least, of a characteristic size of the desired geometrical shape of the convexity. A characteristic size of the desired geometrical shape of the convexity, within the meaning of the present invention, may be or include, for example, the desired diameter of the convexity or the desired height of the convexity. It is provided, in particular, that the temperature is selected as a function of the desired diameter of the convexity and the desired height of the convexity. The desired geometrical shape is especially a function of the dimensions of the lens that is to be produced.

In one embodiment of the present invention, the convexity is pressed, using a first mold, at a pressure, at a speed and/or an acceleration which are selected as a function of the desired geometrical shape of the convexity or at least of the characteristic size of the desired geometrical shape of the convexity.

In one embodiment of the present invention, at least a measurement of the first mold is selected as a function of the desired geometrical shape of the convexity or, at least, of the characteristic size of the desired geometrical shape of the convexity. Such a measurement is particularly the diameter of an opening of the first mold, in which the convexity is generated.

In one embodiment of the present invention, the glass blank or the glass ingot is heated or warmed up between the pressing of the convexity using the first mold and the pressing of the convexity into the second mold.

In one embodiment of the present invention, the glass blank or the glass ingot is heated or warmed up in a tube furnace. A tube furnace within the meaning of the present invention is particularly a furnace that is open or may be opened at the top and the bottom. In one embodiment of the present invention, the tube furnace is situated below a press or a press assembly for pressing the precision lens. In one embodiment of the present invention, the glass blank or glass ingot is moved into the tube furnace on a cooled carrier. Such a carrier forms especially a press bottom or at least a part of a press bottom. In this way, an especially precise pressing of precision lenses is achieved.

In one embodiment of the present invention, less than 10 minutes elapse between the beginning of the pressing of the convexity using the first mold and the ending of the pressing of the convexity into the second mold.

In one embodiment of the present invention, the pressing of the convexity into the second mold takes place in less than 200 s, especially less than 60 s, after the pressing of the convexity using the first mold.

In one embodiment of the present invention, the glass blank or the glass ingot is heated, before the pressing of the convexity using the first mold, for a first heating interval, and, between the pressing of the convexity using the first mold and the pressing of the convexity into the second mold, it is heated or warmed up for a second heating interval, the first heating interval amounting to 1.5 times to 4 times, especially twice the second heating interval.

In one embodiment of the present invention, the glass blank or the glass ingot, or rather a precision lens blank pressed from the convexity of the glass blank or the glass ingot is ground on the side facing away from the convexity.

The object named above is also attained by a method, including especially one or more of the features named above, for producing an optical precision lens, into an essentially plane surface of a glass blank or a glass ingot, at least two, and (as a function of the objective and the geometry of the precision lenses to be pressed) especially as many as possible convexities being pressed using a first mold, without the first mold touching the surface of the convexities, or a substantial part of the convexities, and the convexities being pressed into a second mold (especially into an array of precision lenses), the second mold touching a considerable part of the convexities.

In one embodiment of the present invention, the glass blank or the glass ingot, or rather, a precision lens array pressed from the glass blank or the glass ingot, is ground on a side facing away from the convexities to the extent that the convexities fall apart into individual precision lenses or that the precision lens array falls apart into individual precision lenses.

The object mentioned above is also attained by a method for producing an optical precision lens, the precision lens being pressed from a glass blank, a glass ingot or a precision lens blank using a mold, and/or the precision lens blank being pressed from a glass blank or a glass ingot, using a mold, and the glass blank, the glass ingot or the precision lens blank being heated before being pressed in a tube furnace situated below the mold in the area of the mold. In one embodiment of the present invention, in this context, the precision lens, or the precision lens blank, is pressed at a distance between 50 mm and 300 mm above the tube furnace.

The object named above is also attained by a device for producing an optical lens, especially for producing a precision lens, especially according to a method including one or more of the features named above, the device including press equipment
having a first mold for pressing a convexity into an essentially plane surface of a glass blank or a glass ingot, without the first mold touching the surface of the convexity or a substantial part of the convexity, and
having a second mold into which the convexity may be pressed in such a way that the second mold touches a substantial part of the convexity.

In one embodiment of the present invention, a tube furnace is provided, or rather, the device includes a tube furnace. The tube furnace is especially situated below the pressing equipment.

In one embodiment of the present invention, a carrier is provided, that may be moved from below through the tube furnace for taking up the glass blank or the glass ingot, or the device includes a carrier that may be moved from below through the tube furnace for taking up the glass blank or the glass ingot. In one embodiment of the present invention, the carrier may be cooled. The carrier forms especially a press bottom or at least a part of a press bottom.

The object named above is also attained by a device for producing an optical precision lens, especially according to a method including one or more of the features named above, the device including press equipment having a mold for pressing the lens, especially the precision lens, as well as a tube furnace situated below the press equipment in the area of the mold. In one embodiment of the present invention, a carrier is provided, that may be moved from below through the tube furnace for taking up a glass blank or a glass ingot, or the device includes a carrier that may be moved from below through the tube furnace. In one embodiment of the present invention, the carrier may be cooled. The carrier forms especially a press bottom or at least a part of a press bottom. The tube furnace is situated especially at a distance between 50 mm and 300 mm below an upper side of the press bottom, or in a position in which the lens or the precision lens is pressed.

A tube furnace, situated underneath a press equipment, a mold or a press bottom (in the area of the mold) or underneath a position in which a lens or a precision lens is pressed, within the meaning of the present invention, is, especially, substantially or for the most part situated vertically beneath the mold, the press bottom or the position in which the lens or the precision lens is pressed.

Further advantages and details are derived from the following description of exemplary embodiments.

### BRIEF DESCRIPTION OF THE DRAWINGS

FIG. 1 shows a device shown in a basic representation for producing lenses, especially precision lenses;

FIG. 2 shows a sequence of a method for producing lenses, especially precision lenses;

FIG. 3 shows a glass ingot;

FIG. 4 shows a first pressing method step;

FIG. 5 shows a glass ingot according to the first pressing method step as in FIG. 4;

FIG. 6 shows a second pressing method step;

FIG. 7 shows a glass ingot according to the second pressing method step as in FIG. 6;

FIG. 8 shows a precision lens integrator plate;

FIG. 9 shows a precision lens;

FIG. 10 shows a first mold;

FIG. 11 shows an exemplary positioning of a tube furnace; and

FIG. 12 shows a glass blank in a press position above a tube furnace.

### DETAILED DESCRIPTION OF PREFERRED EXEMPLARY EMBODIMENTS

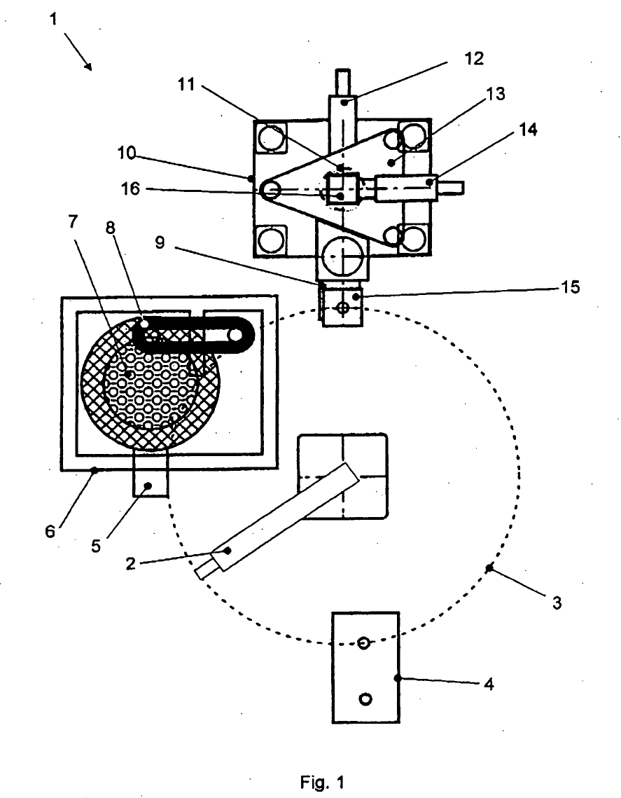

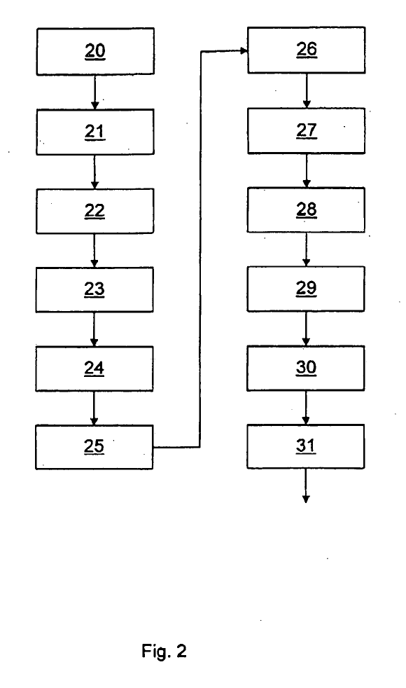

FIG. 1 shows a device 1, shown in a basic representation, for carrying out a method, shown in FIG. 2, for producing lenses, particularly precision lenses. Device 1 includes an annealing oven 6, press equipment 10, a transfer position 4 and a robot 2 for exchanging glass blanks between annealing oven 6, press equipment 10 and transfer position 4. In this context, reference numeral 3 indicates positions able to be reached by robot 2.

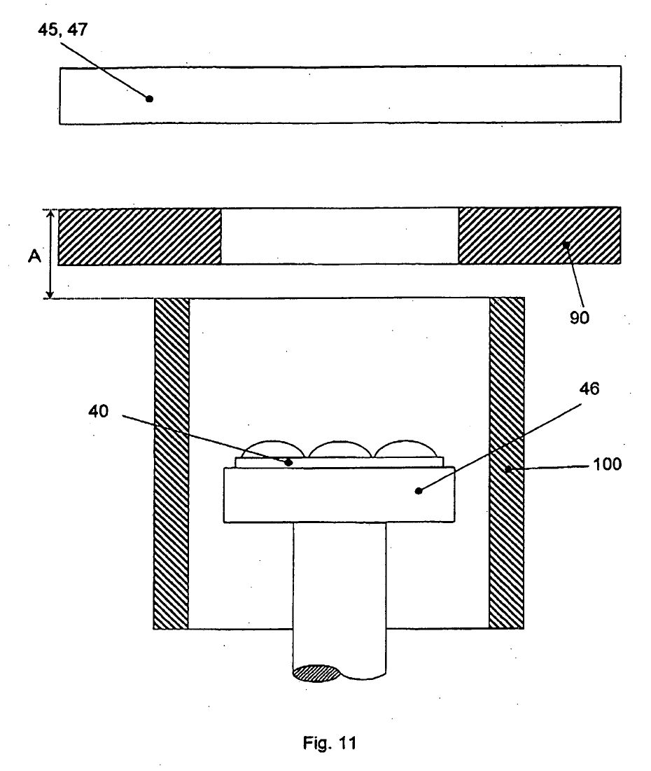

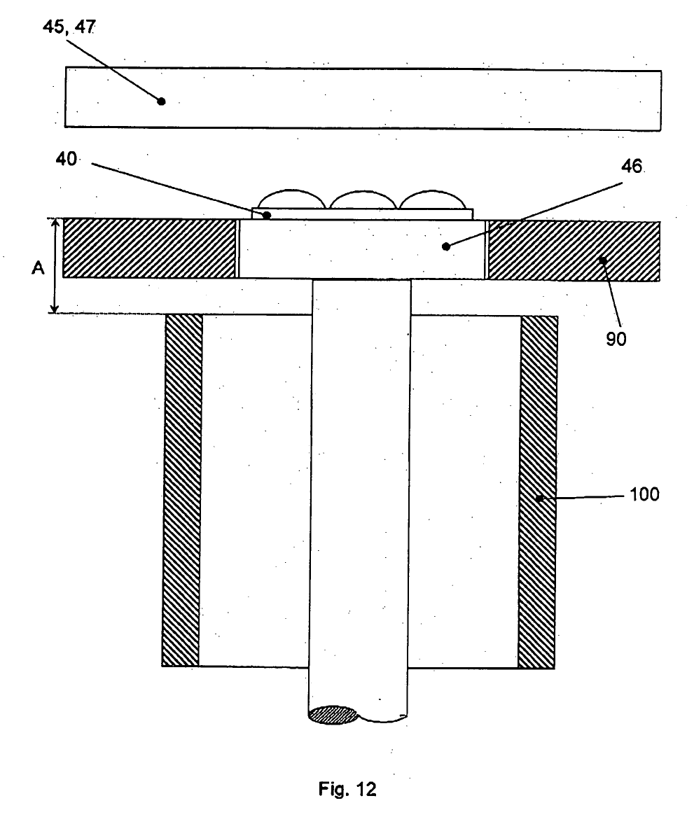

Press equipment 10 includes a transfer position 9 and an oven 15 that is situated above it and opens downwards. Press equipment 10 also includes a press assembly 16 situated on a press table 13, which is operable using a motor 14. Press table 13 includes an opening not shown in FIG. 1, that is situated underneath press assembly 16. Underneath press assembly 16 there is situated a tube furnace that is indicated in FIG. 1 by a broken-lined circle having reference numeral 11, and is shown in greater detail in FIG. 11 and FIG. 12.

Annealing oven 6 includes a transfer position 5, a material pick-up 7 and a heat register 8.

The starting product of the method described with reference to FIG. 2, for producing lenses, especially precision lenses, is ingot glass, i.e. a glass ingot. Ingot glass has a very clean surface in response to appropriately careful treatment. From these glass ingots, without damaging the surface, in one step 20, as shown in FIG. 3 in exemplary fashion, in perspective, glass blanks 40 are produced in the form of cubes, parallelepiped blocks or log-shaped figures (having essentially a planar surface). After cleaning, these glass blanks 40 are placed on a timed supply belt, and, at the transfer position designated in FIG. 1 by reference numeral 4 are offered to the robot designated by 2 in FIG. 1.

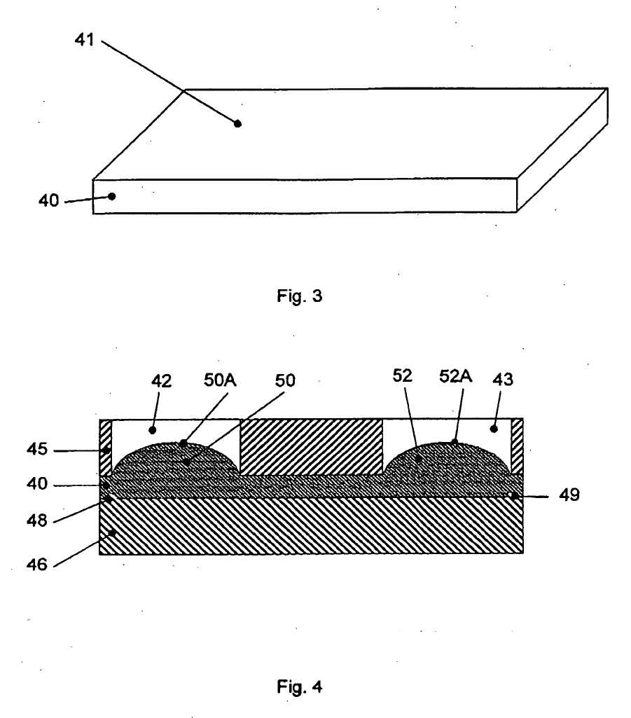

A glass blank 40 to be pressed is passed, in step 21, by robot 2 to transfer position 9 of press equipment 10, and, using a lance, is moved from below into oven 15 that is open in the downwards direction. In oven 15, glass blank 40 is heated, in a first heating phase 22, for an adjustable first heating interval, to a predetermined pressing temperature (in particular, between 400° C. and 950° C.). Heating phase 22 is followed by step 23, in which the lance and heated glass blank 40 are withdrawn from oven 15, glass blank 40 is transferred to a linear transfer device 12, and conveyed from this to press assembly 16 using a cooled carrier 46, shown in FIG. 4, which lifts off glass blank 40 from linear transfer device 12. Carrier 46 forms especially a press bottom or at least a part of a press bottom. Linear transfer device 12 subsequently moves, opened, away from the press area.

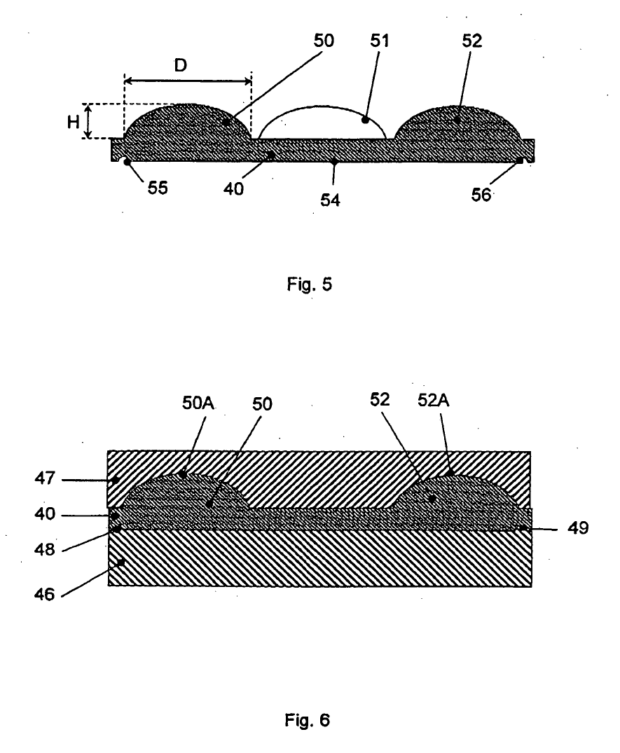

Step 23 is followed by a first pressing method step 24, in which, as shown in FIG. 4 as basic representation, using a first mold 45, into essentially planar surface 41 of blank 40 convexities 50, 51 (cf. FIG. 5), 52, that is, in particular, “mounds” are pressed, without the first mold 45 touching surfaces 50A, 52A of convexities 50, 52 or a substantial part of convexities 50, 52. For this, mold 45 is designed as a hole matrix having right through holes 42, 43. However, holes 42, 43 may also be closed on a side facing away from glass blank 40. In that case, holes 42, 43 should be so deep that surfaces 50A, 52A of convexities 50, 51, 52 do not touch first mold 45. An important part of a convexity 50, 52 is, in particular, that part of convexity 50, 52 which, or rather, whose surface 50A, 52A influences the optical properties of a lens or a precision lens pressed from convexity 50, 51, 52.

The shape of holes 42, 43 of first mold 45 is selected especially as a function of the desired geometrical shape of convexities 50, 51, 52, or at least of a characteristic size, such as, for example, as shown in exemplary fashion in FIG. 5, the desired diameter D of a corresponding convexity 50 and/or, as shown in exemplary fashion in FIG. 5, the desired height H of a corresponding convexity 50, of the desired geometrical shape. In addition, a selection is made, in particular, of the pressing pressure, the pressing speed and/or the pressing acceleration as a function of the desired geometrical shape of convexities 50, 51, 52, or at least of a characteristic size of the desired geometrical shape. In addition, it is provided in one embodiment that the pressing temperature is selected as a function of the desired geometrical shape of convexities 50, 51, 52, or at least of a characteristic size of the desired geometrical shape. The desired geometrical shape of convexities 50, 51, 52 or the characteristic size of the desired geometrical shape is especially a function of the contour of a precision lens that is to be pressed later. The desired geometrical shape or the desired diameter D of a corresponding convexity 50 and/or the desired height H of a corresponding convexity 50 are adjusted particularly to the precision lens that is to be pressed later. In this context, in one embodiment, diameter D of convexity 50 should amount to 50% to 70%, especially about ⅔, of the later lens diameter, and/or height H of corresponding convexity 50 should be 10% to 30% greater than the corresponding size of a precision lens that is to be pressed later.

In one embodiment, (small) bulges 48, 49 are provided in carrier 46, to which, on a side 54 of glass blank 40 facing away from convexities 50, 51, 52, indentations 55, 56, shown in FIG. 5, for aligning glass blank 40, may be pressed. In this way, an especially suitable possibility of fixing glass blank 40 to carrier 46 may be created.

First pressing method step 24 is followed by a step 25, in which glass blank 40 on carrier 46 is retracted into tube furnace 11 that is located under press table 13.

In a second heating phase 26 following step 25, glass blank 40, as shown in an exemplary fashion in FIG. 11, is heated or warmed up in the tube furnace designated in FIG. 11 and FIG. 12 by reference numeral 100 for a second heating interval, the first heating interval amounting to the 1.5-fold to the 4-fold, particularly the approximately 2-fold, of the second heating interval. It is particularly provided that the second heating interval amounts to less than 200 s, especially less than 60 s. During heating phase 26, first mold 45 is exchanged for a second mold 47, shown in FIG. 6, that is designed as a precision mold.

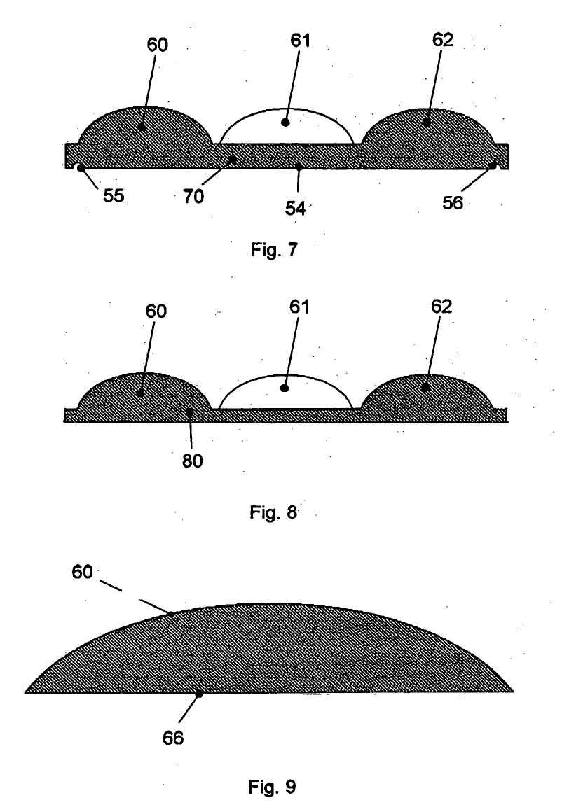

In a step 27 following second heating phase 26, glass blank 40, as indicated in FIG. 12, is moved, using carrier 46, against a second mold 47, and in a second pressing method step 28 (possibly under vacuum) is pressed as shown in FIG. 6 as basic representation. In this context, convexities 50, 51, 52 are pressed into second mold 47 in such a way that second mold 47 touches a substantial part of corresponding convexities 50, 51, 52. In this context, convexities 50, 51, 52, as shown in FIG. 7, are pressed to form precision lenses 60, 61, 62, so that, from glass blank 40, a precision lens blank or a precision lens array 70 is pressed. Second pressing method step 28, in particular, is closed, at the latest, 10 minutes after the beginning of first pressing method step 24.

In a subsequent step 29, precision lens array 70 thus pressed from glass blank 40 is released from the mould, for instance, by vibration or vacuum, and transferred to robot 2, which transfers precision lens array 70 to annealing oven 6, or rather its transfer position 5.

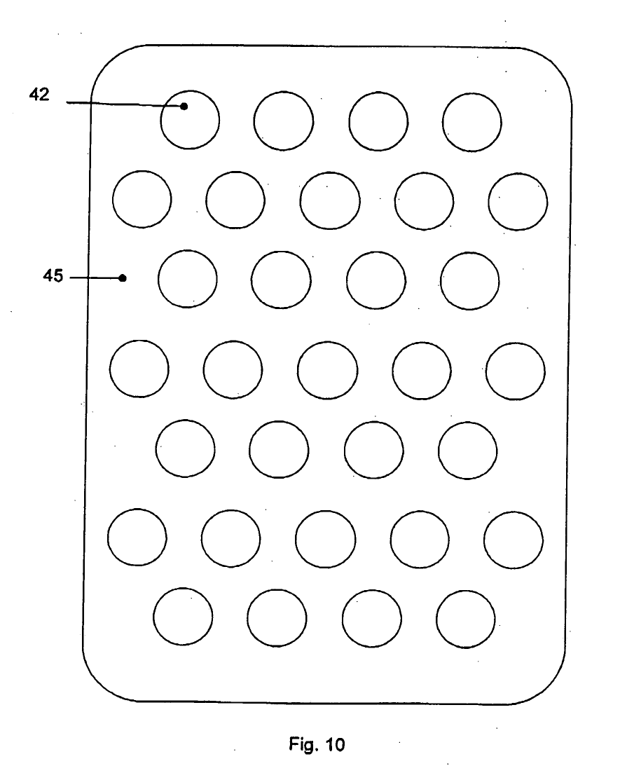

In a further step 30, precision lens array 70 is slowly cooled in material accommodation 7 of annealing oven 6. When all precision lens arrays in annealing oven 6 have been sufficiently cooled, a side 54 facing away from precision lenses 60, 61, 62 of precision lens array 70 is
ground to the extent that, as shown in FIG. 8, a precision lens integrator plate 80 is created, or
at least ground to the extent that precision lenses 60, 61, 62 of precision lens array 70, as shown in FIG. 9, fall apart into individual precision lenses 60, 61, 62.

An additional step 31 may be provided, in which a surface 66, created by grinding of precision lens integrator plate 80 or of precision lens 60, is polished.

FIGS. 4 and 6 show simplified illustrations of first mold 45, second mold 47, or carrier 46. Thus, it may be provided that first mold 45, as shown in FIG. 10 in a top view of first mold 45, has a plurality of holes. It may also be provided that first mold 45 and carrier 46 and/or second mold 47 and carrier 46 touch at their edges during pressing by corresponding formations.

It may be provided that, in an alternative embodiment of step 23, glass blank 40 is conveyed all the way through tube furnace 100 to press assembly 16.

It may be provided that carrier 46 is heated. It may, in particular, be provided that carrier 46 is heated by the furnace radiation of tube furnace 100 in such a way that it has a surface temperature of ca. 400° C.

FIG. 11 and FIG. 12 show an exemplary arrangement of tube furnace 100 in a basic representation. The tube furnace 100 is situated especially at a distance between 50 mm and 300 mm below an upper side of the press bottom, designated by reference numeral 90, or in a press position in which the lens or the precision lens is pressed.

The elements in the figures are drawn with simplicity and clarity in mind, and not necessarily to an exact scale. Thus, for example, the orders of magnitude of some elements are exaggerated as compared to other elements in order to facilitate understanding of the exemplary embodiments of the present invention.

What is claimed is:

1. A method for producing an optical precision lens, the method including:
pressing a convexity into an essentially planar surface of a glass blank or a glass ingot, using a first mold, without the first mold touching the surface of the convexity or a substantial part of the convexity; and
pressing a convexity into a second mold, the second mold touching a substantial part of the convexity.

2. The method as recited in claim 1, further encompassing:
heating the glass blank or the glass ingot to a certain temperature before pressing the convexity using the first mold.

3. The method as recited in claim 2, further encompassing:
selecting the temperature as a function of a desired geometrical shape of the convexity, or at least of a characteristic size of the desired geometrical shape of the convexity.

4. The method as recited in claim 1,
the convexity being pressed, using the first mold, using a pressure which is selected as a function of the desired geometrical shape of the convexity, or at least of the characteristic size of the desired geometrical shape of the convexity.

5. The method as recited in claim 1, further encompassing:
selecting at least one measure of the first mold as a function of a desired geometrical shape of the convexity, or at least of a characteristic size of the desired geometrical shape of the convexity.

6. The method as recited in claim 1, further encompassing:
heating the glass blank or the glass ingot between the pressing of the convexity using the first mold and the pressing of the convexity into the second mold.

7. The method as recited in claim 1, further encompassing:
heating the glass blank or the glass ingot in a tube furnace between the pressing of the convexity using the first mold and the pressing of the convexity into the second mold.

8. The method as recited in claim 6, further encompassing:
moving the glass blank or the glass ingot into the tube furnace on a cooled carrier.

9. The method as recited in claim 1,
between the beginning of the pressing of the convexity, using the first mold, and the ending of the pressing of the convexity into the second mold, there expiring not more than essentially 10 minutes.

10. The method as recited in claim 1,
the pressing of the convexity into the second mold taking place in less than essentially 200 s after the pressing of the convexity using the first mold.

11. The method as recited in claim 1, further encompassing:
heating the glass blank or the glass ingot for a first heating interval before the pressing of the convexity using the first mold,
heating the glass blank or the glass ingot for a second heating interval between the pressing of the convexity using the first mold and the pressing of the convexity into the second mold, the first heating interval amounting to the essentially 1.5-fold to the essentially 4-fold of the second heating interval.

12. The method as recited in claim 1, further encompassing:
grinding of the glass blank or the glass ingot or a precision lens blank pressed from the glass blank or the glass ingot on a side facing away from the convexity, after the pressing of the convexity into the second mold.

13. A method for producing an optical precision lens, the method including:
pressing at least two convexities into an essentially planar surface of a glass blank or a glass ingot, using a first mold, without the first mold touching the surface of the convexities or a substantial part of the convexities; and
pressing the convexities into a second mold, the second mold touching a substantial part of the convexities.

14. The method as recited in claim 13, further encompassing:
heating the glass blank or the glass ingot to a certain temperature before pressing the convexities using the first mold.

15. The method as recited in claim 14, further encompassing:
selecting the temperature as a function of a desired geometrical shape of the convexities, or at least of a characteristic size of the desired geometrical shape of the convexities.

16. The method as recited in claim 13,
the convexities being pressed, using the first mold, using a pressure which is selected as a function of the desired geometrical shape of the convexities, or at least of the characteristic size of the desired geometrical shape of the convexities.

17. The method as recited in claim 13, further encompassing:
selecting at least one measure of the first mold as a function of a desired geometrical shape of the convexities, or at least of a characteristic size of the desired geometrical shape of the convexities.

18. The method as recited in claim 13, further encompassing:
heating the glass blank or the glass ingot between the pressing of the convexities, using the first mold, and the pressing of the convexities into the second mold.

19. The method as recited in claim 13, further encompassing:
heating the glass blank or the glass ingot in a tube furnace between the pressing of the convexities, using the first mold, and the pressing of the convexities into the second mold.

20. The method as recited in claim 19, further encompassing:
moving the glass blank or the glass ingot into the tube furnace on a cooled carrier.

21. The method as recited in claim 19,
the convexities being pressed into the second mold at a distance between 50 mm and 300 mm above the tube furnace.

22. The method as recited in claim 13,
between the beginning of the pressing of the convexities, using the first mold, and the ending of the pressing of the convexities into the second mold, there expiring not more than essentially 10 minutes.

23. The method as recited in claim 13,
the pressing of the convexities into the second mold taking place in less than essentially 200 s after the pressing of the convexities using the first mold.

24. The method as recited in claim 13, further encompassing:
heating the glass blank or the glass ingot for a first heating interval before the pressing of the convexity using the first mold; and
heating the glass blank or the glass ingot for a second heating interval between the pressing of the convexity using the first mold and the pressing of the convexity into the second mold, the first heating interval amounting to the essentially 1.5-fold to the essentially 4-fold of the second heating interval.

25. The method as recited in claim 13, further encompassing:
grinding of the glass blank or the glass ingot or a precision lens blank, pressed from the glass blank or the glass ingot, on a side facing away from the convexities, after the pressing of the convexity into the second mold, that the convexities fall apart into individual precision lenses.

26. A method for producing an optical precision lens, the method encompassing:
heating a glass blank, a glass ingot or a precision lens blank in a tube furnace situated beneath a mold in the area of the mold; and
pressing the precision lens from the glass blank, from the glass ingot or from the precision lens blank, using the mold.

27. The method as recited in claim 26,
the precision lens being pressed at a distance between 50 mm and 300 mm above the tube furnace.

28. A device for producing precision lenses, the device encompassing press equipment, the press equipment encompassing:
a first mold for pressing a convexity into an essentially planar surface of a glass blank or a glass ingot, without the first mold touching the surface of the convexity or a substantial part of the convexity; and
a second mold into which the convexity may be pressed in such a way that the second mold touches a substantial part of the convexity.

29. The device as recited in claim 28,
the device also encompassing a tube furnace.

30. The device as recited in claim 29,
the tube furnace being situated below the pressing equipment.

31. The device as recited in claim 30,
the device also encompassing a carrier that may be moved through the tube furnace from below.

32. The device as recited in claim 31,
the carrier being able to be cooled.

33. The device for producing precision lenses, the device encompassing:
a pressing equipment having a mold for pressing the precision lens; and
a tube furnace situated beneath the pressing equipment in the area of the mold.

34. The device as recited in claim 33,
the device also encompassing a carrier that may be moved through the tube furnace from below.

35. The device as recited in claim 34,
the carrier forming a press bottom or at least a part of a press bottom.

36. The device as recited in claim 35,
the tube furnace being situated at a distance between 50 mm and 300 mm beneath an upper side of the press bottom.

37. The device as recited in claim 33,
the tube furnace being situated at a distance between 50 mm and 300 mm beneath a position for pressing the precision lens.
